(19) United States
(12) Patent Application Publication
(10) Pub. No.: US 2011/0282944 A1
(43) Pub. Date: Nov. 17, 2011

(54) SYSTEMS AND METHODS FOR CONTENT SHARING ACROSS ENTERPRISE SOCIAL NETWORKS

(75) Inventors: Donald Tucker Henderson, Mountain View, CA (US); James Wu, Sunnyvale, CA (US); Randy Nasson, San Francisco, CA (US); Jonathan Pollock, Berkley, MA (US); Petrus Handoko, Saratoga, CA (US); Charles David Boyer, Union City, CA (US); Ramesh Anantharamaiah, Bangalore (IN); Pehong Chen, Atherton, CA (US)

(73) Assignee: Broadvision, Redwood City, CA (US)

(21) Appl. No.: 13/106,690

(22) Filed: May 12, 2011

Related U.S. Application Data
(60) Provisional application No. 61/334,504, filed on May 13, 2010.

(51) Int. Cl. G06F 15/16

(52) U.S. Cl. 709/204

(57) ABSTRACT

Systems and methods for sharing content over a collection of social networks are disclosed. In one embodiment, a system comprises a first social network, a second social network, and at least one sharing table. The at least one sharing table is configured to share a first content from the first social network with the second social network.

### CROSS-REFERENCE TO RELATED APPLICATIONS

The disclosure claims priority to U.S. Provisional Patent Application No. 61/334,504 filed May 13, 2010 entitled “SYSTEMS AND METHODS FOR CONTENT SHARING ACROSS ENTERPRISE SOCIAL NETWORKS”, which is herein incorporated by reference in its entirety.

### BACKGROUND

1. Field of the Invention

The present invention relates to systems and methods for content sharing across enterprise social networks.

2. Description of the Related Art

The distribution and sharing of content, such as documents, multimedia data, or blog or forum data can be important for a business or other organization. Company networks, such as corporate intranets or support Websites, typically manage content distribution to users within the network and to the public at large.

It can be difficult to communicate content over multiple networks. Even if the owner of the content is a member of and has permission to distribute content to each target network, the networks can each have different systems for content distribution and control. Furthermore, once the content is distributed, the content can subsequently be modified in one network, leading to difficulties in content management and version control. Moreover, when distributing content to multiple networks, typically the content must be separately stored in storage associated with each network, leading to inefficient use of storage capacity.

### SUMMARY

The systems, methods and devices of the present disclosure each have several innovative aspects, no single one of which is solely responsible for the desirable attributes disclosed herein.

In one aspect, a method in a server for sharing content over a collection of social networks is provided. The method includes receiving a first content from a first user of a first social network, receiving information identifying a second social network, and sharing the first content with the second network by providing a content association to a sharing table.

In another aspect, a system for sharing content over a collection of social networks is provided. The system includes a first social network, a second social network, and at least one sharing table for sharing a first content from the first social network with the second social network.

In another aspect, a non-transitory computer-readable storage medium including instructions that when executed perform a method in a server for sharing content over a collection of social networks is provided. The method includes receiving a first content from a first user of a first social network, receiving information identifying a second social network, and sharing the first content with the second network by providing a content association to a sharing table.

In another aspect, a system for sharing content over a collection of social networks is provided. The system includes a first social network, a second social network, and at least one means for sharing a first content from the first social network with the second social network.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

Specific embodiments of the invention will now be described with reference to the following drawings, which are provided by way of example, and not limitation.

FIG. 1 is a schematic block diagram of a network in accordance with one embodiment.

FIG. 2A is a schematic block diagram of a master ecosystem in accordance with one embodiment.

FIG. 2B is a schematic block diagram of a master ecosystem in accordance with another embodiment.

FIG. 3A is a schematic block diagram of a server in accordance with one embodiment.

FIG. 3B is a schematic block diagram of a server in accordance with another embodiment.

FIG. 4 is a flowchart of a method of sharing content across multiple networks in accordance with one embodiment.

FIG. 5A is a flowchart of a method of updating one or more network tables to reflect the sharing of content within an ecosystem in accordance with one embodiment.

FIG. 5B is a flowchart of a method of updating one or more network tables to reflect the sharing of content within a master ecosystem in accordance with one embodiment.

FIG. 6 is a flowchart of a method of retrieving content shared across a plurality of networks in accordance with one embodiment.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals indicate identical or functionally similar elements.

Embodiments of the invention relate to systems and methods for sharing content within and between social networks. For example, a company may setup a series of communities that each has their own social network. A collection of social networks is referred to as an ecosystem. In one example, the accounting, marketing, product development and engineering departments would each be a community with their own social network. However, employees in one of the communities may wish to share information with other employees in other communities. For example, an engineer in the engineering community may wish to share a blog entry commenting on a company picnic with employees in the accounting community. Embodiments of the invention allow an employee with the proper permissions to post content to any community within their network.

For example, two companies may each have an ecosystem that includes a series of social networks. Within each network at the company are communities of users or employees. For example, an accounting network may include different accounting communities, wherein each community relates to a specific geographic location of an accounting department. The accounting department in one city would be one community, and the accounting department in a second city would be a second community. However, they would both be part of the accounting social network for the company.

In one example, one company is a supplier to another company that is the purchaser. An ecosystem could encompass both the supplier and the purchaser companies. The supplier company, as described above, could have networks of communities all with their own social networks. However, the system can also manage content distribution within the ecosystem and between the companies, such that users in the purchaser company can post content to be viewed by users in the supplier company. Thus, the system can be used to provide communication between various companies, based on permissions set for each user in the ecosystem.

Furthermore, in certain embodiments, the system can aid a user in receiving content from a multitude of networks. For example, a vice president of a company may be actively involved in a variety of networks, including an accounting department, a sales department, and a product development department. The vice president may need repeated access to status updates, news feeds, and a wide variety of other content across these networks. The system can permit the vice president to view all of this content sent to him from any network in the ecosystem. Additionally, for appropriate types of content, the vice president can reply to the content and the reply will be delivered appropriately.

Moreover, in certain embodiments, a company can have multiple networks for various suppliers. The company may need to provide a policy update to all of the suppliers. Using the system, the company can provide a policy document across the networks. Furthermore, the company may later update the document to reflect a correction, and the document will be automatically updated across all networks.

### DEFINITIONS

As used herein, an input device can be, for example, a keyboard, rollerball, mouse, voice recognition system or other device capable of transmitting information from a user to a computer. The input device can also be a touch screen associated with the display, in which case the user responds to prompts on the display by touching the screen. The user may enter textual information through the input device such as the keyboard or the touch-screen.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A Local Area Network (LAN) or Wide Area Network (WAN) may be a corporate computing network, including access to the Internet, to which computers and computing devices comprising the system are connected. In one embodiment, the LAN conforms to the Transmission Control Protocol/Internet Protocol (TCP/IP) industry standard.

As used herein, media refers to images, sounds, video or any other multimedia type data that is entered into the system.

A microprocessor may be any conventional general purpose single- or multi-chip microprocessor such as a Pentium® processor, Itanium® processor or an ALPHA® processor. In addition, the microprocessor may be any conventional special purpose microprocessor such as a digital signal processor (DSP) or a graphics processor.

The system is comprised of various modules as discussed in detail below. As can be appreciated by one of ordinary skill in the art, each of the modules comprises various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as LINUX, UNIX or MICROSOFT WINDOWS®.

The system may be written in any conventional programming language such as C, C++, BASIC, Pascal, Perl, or Java, and run under a conventional operating system.

A web browser comprising a web browser user interface may be used to display information (such as textual and graphical information) to a user. The web browser may comprise any type of visual display capable of displaying information received via a network. Examples of web browsers include Microsoft's Internet Explorer browser, Mozilla's Firefox browser, PalmSource's Web Browser, Google's Chrome browser or any other browsing or other application software capable of communicating with a network.

The invention disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices.

### System Overview

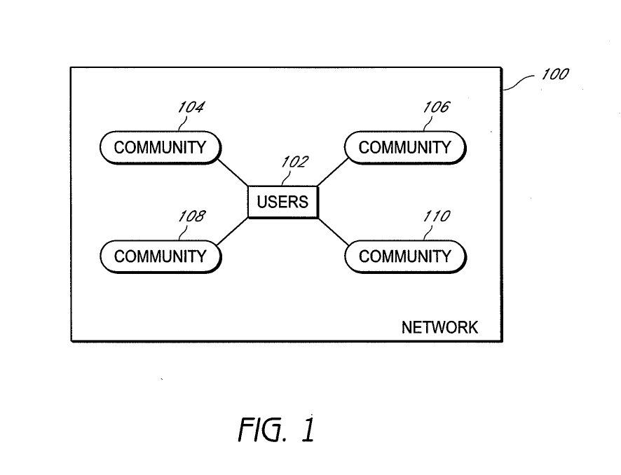

FIG. 1 is a schematic block diagram of a network 100 in accordance with one embodiment. The enterprise social network or network 100 can include a multitude of users 102. As shown in FIG. 1, the network 100 can include one or more communities, such as a first community 104, a second community 106, a third community 108 and a fourth community 110. Each user can belong to one or more of the communities.

The network 100 can be, for example, a company intranet or support Website hosted on one or more servers. The users 102 can be members of the network 100, and can interact with the network 100 using a user interface (UI) through a device such as a computer, personal digital assistant (PDA) and/or mobile phone. Each user can be prompted for a password before logging into the network 100. A user of the network 100 can belong to one or more communities within the network 100. For example, a first user can belong to the first community 104 and to the second community 106, a second user can belong to the third community 108, and a third user can belong to none of the communities. The communities can represent, for example, various groups within a company or organization, such as an engineering group, a human resource group, or a sales group.

A social network can include a website that is designed to allow users of that network to communicate with one another. For example, in one implementation, a community has a community network page that is accessible by each user. The community page may be an intranet webpage that is only accessible by members of a particular company, or it may be an Internet page that is setup for a community that is not part of any particular company.

The community webpage may include features, such as a blog applet, that allows community users to update content, such as adding comments, to a blog on the webpage. In other implementations, photographs, videos, documents, and/or any other content may be updated based on the features of the particular community webpage.

In certain embodiments described herein, a permissions module or system manages the user's ability to post content to the community webpage. In addition, in some implementations, the permissions module also manages the ability of the user to post content to other communities, other networks, and/or other groups of networks within an ecosystem. Furthermore, in some embodiments, the permissions module controls access that allows a user with the right permissions to post content from one ecosystem to another ecosystem.

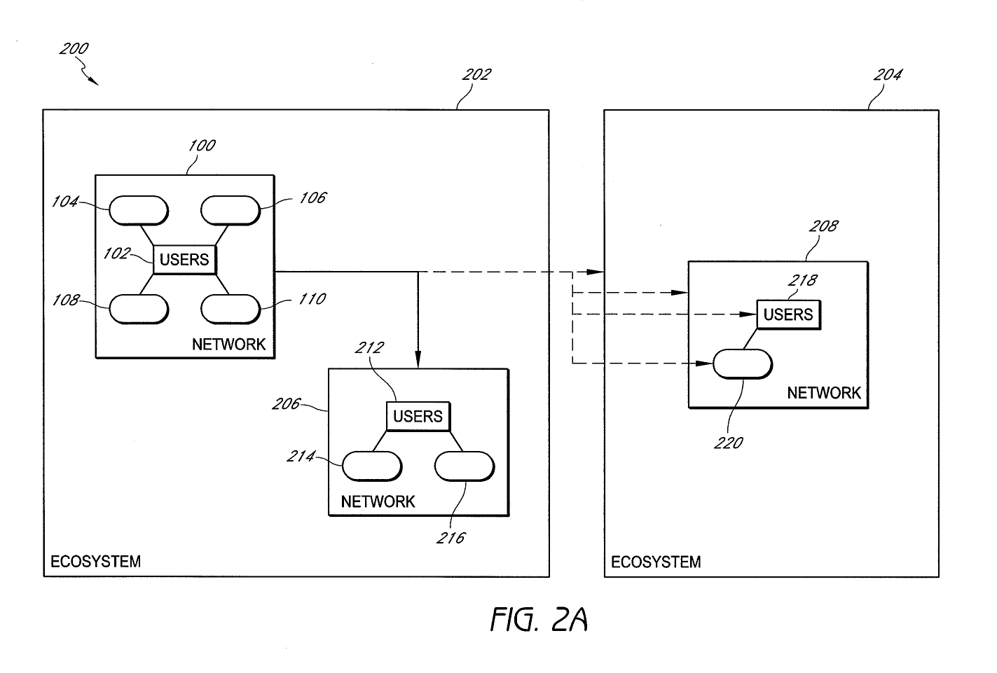

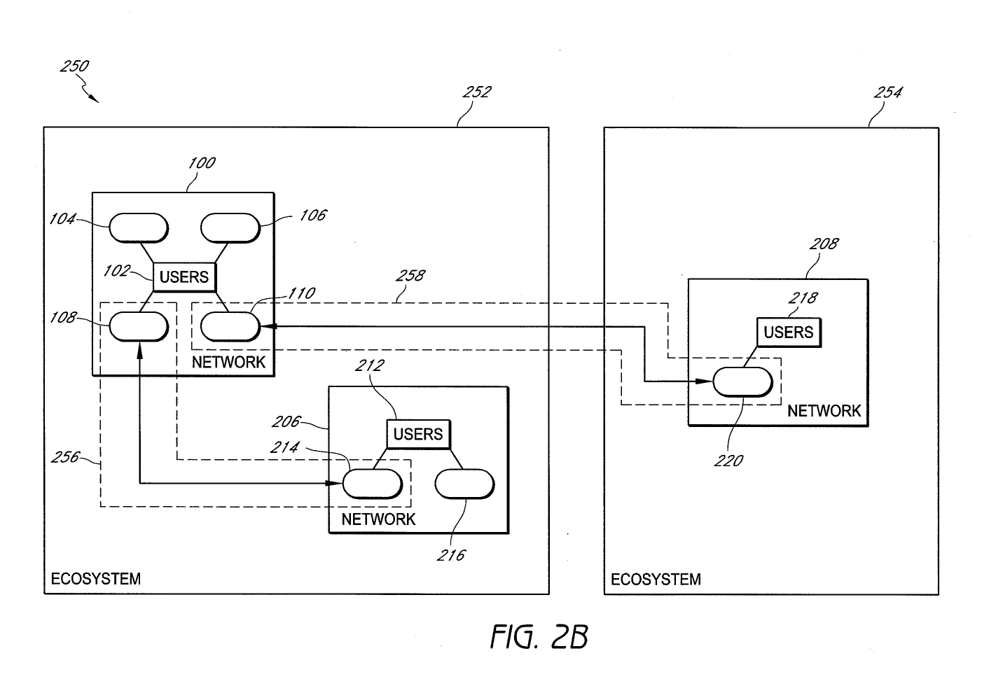

FIG. 2A is a schematic block diagram of a master ecosystem 200 in accordance with one embodiment. The illustrated master ecosystem 200 includes a first ecosystem 202 and a second ecosystem 204. The first and second ecosystems 202, 204 can include one or more networks. For example, as shown in FIG. 2A, the first ecosystem 202 includes a first network 100 and a second network 206, and the second ecosystem 204 includes a third network 208. Each network can include users and communities, as was described above with reference to FIG. 1. The first network 100 includes users 102, and communities 104, 106, 108, 110, the second network 206 includes users 212 and communities 214, 216, and the third network 208 includes users 218 and community 220.

As will be described in detail below, in certain embodiments content can be shared within the ecosystems 202, 204, thereby improving document sharing over multiple networks and enhancing a user's ability to participate in multiple networks. A single user can belong to a multitude of communities and networks within an ecosystem, and a user can share content to one or more users, communities or networks within the ecosystem to which the user belongs. Thus, a first user of the users 102 having sufficient permission can distribute and provide varying permission to content to one or more of the users 102, to one or more of the communities 104, 106, 108, 110, and/or to one or more of the networks 100, 206 within the first ecosystem 202.

Additionally, in certain implementations, a user of the users 102 having sufficient permission can distribute and provide varying permissions to content to the second ecosystem 204. For example, a user can distribute content and provide a level of access to content, such as read or read and write, to one or more users, one or more communities, and/or one or more networks in the master ecosystem 200. Thus, in these embodiments, a first user of the users 102 within the first ecosystem 202 having sufficient permission can share content with the second ecosystem 204 by sharing the content to the network 208, the community 220, or to one or more of the users 218 of the second ecosystem 204. Each of these sharing relationships is shown in FIG. 2A with dashed lines.

Permitting the sharing of content over a plurality of networks and/or across ecosystems can reduce the amount of data storage while providing content access control, as will be described in further detail below with reference to FIG. 3. Additionally, in certain embodiments, the user can track the history of the content through a versioning or log file system, including who downloaded or edited the content, further facilitating document management across multiple networks.

FIG. 2B is a schematic block diagram of a master ecosystem 250 in accordance with another embodiment. The illustrated master ecosystem 250 includes a first ecosystem 252 and a second ecosystem 254. The first and second ecosystems 252, 254 can include one or more networks. For example, as shown in FIG. 2B, the first ecosystem 252 includes the first network 100 and the second network 206, and the second ecosystem 254 includes the third network 208. Each network can include users and communities, as was described above with reference to FIGS. 1 and 2A. The first network 100 includes users 102 and communities 104, 106, 108, 110, the second network 206 includes users 212 and communities 214, 216, and the third network 208 includes users 218 and community 220.

The illustrated master ecosystem 250 also includes a first shared community 256 and a second shared community 258. The first shared community 256 includes the community 108 of the first network 100 and the community 214 of the second network 206, and can be used to share content across the first and second networks 100, 206. Additionally, the second shared community 258 includes the community 110 of the first network 100 and the community 220 of the third network 208, and can be used to share content across the first and third networks 100, 208.

The first and second shared communities 256, 258 can aid in sharing content across different networks, including, for example, networks located in different ecosystems. For example, a user of the users 102 belonging to the community 108 of the first network 100 having sufficient permission can share content with other members of the community 108 and to members of the community 214 of the second network 206. Similarly, a user of the users 218 belonging to the community 220 of the third network 208 having sufficient permission can share content with other members of the community 220 of the third network 208 and to members of the community 110 of the first network 100. Additional details of content sharing using the shared communities will be described in detail later below.

FIG. 3A is a schematic block diagram of a server 301 in accordance with one embodiment. The illustrated server 301 includes a database cluster 300, content storage 303, a content retrieval module 345, a permissions module 342, an update module 343, and a cloning module 344.

The database cluster 303 can be any suitable database cluster, including, for example, a mySQL database cluster. The database cluster 300 includes a user table 302, first ecosystem tables 304, second ecosystem tables 306, and a master locator table 310. As will be described in detail below, the server 301 can access and store data shared across a plurality of networks within an ecosystem, such as the first and second networks 100, 206 of FIG. 2A. Although the server 301 is illustrated as a single server, the server 301 can comprise a multitude of servers having varying functions to facilitate load balancing or satisfy other needs. The tables 302, 304, 306, 310 can be distributed over one or more databases depending on a variety factors, including server load and frequency of access. Skilled artisans will appreciate that more or fewer tables can be employed than those illustrated.

The user table 302 can include information about the users of the master ecosystem, and can include, for example, information regarding the ecosystems, networks and/or communities to which each user belongs. Furthermore, the user information 302 can include information related to the permissions a user has for distributing content over the ecosystems, networks and/or communities for which the user is a member. However, the user table 302 need not include all the information associated with the user. For example, one or more additional table can store certain auxiliary user information, such as a member photo, personal preferences or settings, or other data. The user table 302 can include a user table entry 311 having user identification 312 and membership and permissions information 313. The user identification 312 can be used to uniquely identify the user within the master ecosystem, and the membership and permissions information 313 can identify ecosystems, networks and/or communities that the user is a member of, and the permissions the user has with respect to those ecosystems, networks and/or communities. As will be described in further detail below, the user table 302 can identify which network databases potentially contain content for which the user has access.

Also shown in FIG. 3A is the permissions module 342 which controls permissions associated with the membership and permissions information 313. In one embodiment, the permissions module 342 runs the method 400 described in more detail below with reference to FIG. 4.

The first ecosystem tables 304 include the content table 307 and the sharing table 308. The first ecosystem tables 304 can contain content associated with the networks within the first ecosystem, as well as information indicating how the content is shared within the ecosystem, as will be described below. In addition to the tables shown, the first ecosystem tables 304 can include additional tables, including tables related to the communities of the ecosystem.

In certain embodiments, the content table 307 can include a content entry 315 for each item of content in the ecosystem. The content can include, for example, images, documents, text, blog entries, and/or other data. The content entry 315 can include a content identifier 316, which can uniquely identify the item of content within the content table 307. The content entry 315 can also include a content description 317, which can identify information related to the content, such as the owner and the type of content. The content description 317 can also contain actual content data or information indicative of where the content is stored. By permitting the content contained within an ecosystem to be stored in the content table 307, content can be stored once within the ecosystem, thereby improving data storage capacity and centralizing version control. In one embodiment, when the content is a file, the content description 317 includes a pointer to a location of the file in the content storage 303. Employing the content storage 303 can aid in storing content of a relatively large size, thereby reducing the size of the content table 307 relative to a content table which directly stores all data.

With continuing reference to FIG. 3A, the sharing table 308 can include entries defining content sharing relationships over an ecosystem. Thus, the sharing table 308 can be used as one means for sharing content between users, networks and/or communities of an ecosystem. For example, the sharing table 308 can include a content association 320 having a source identifier 324, a relationship 326, and a target identifier 328. The source identifier 324 can be, for example, a pointer to the content identifier 316 of the content. The content association 320 can also include the target identifier 328, which can identify the entity which has been provided access to the content. In one embodiment, the target identifier 328 can be a user identifier, a community identifier, or a network identifier.

The content association 320 can also include relationship 326, which can indicate the type of sharing indicated by the content association 320. For example, the relationship field 326 can indicate that the entity defined by the target identifier 328 is a network permitted to view, but not edit, the content.

In certain embodiments, a particular piece of content can have a multitude of corresponding content associations 320 in the sharing table 308. Each of these content associations can have the same source identifier 324 to link to the content, but can have a different relationship 326 and target identifier 328. Thus, content may be shared across particular users, communities, and networks within an ecosystem, with varying degrees of access. Skilled artisans will appreciate that multiple content associations can result in a particular user receiving conflicting access levels. For example, a user can be a member of a particular community, and the community can be granted read access by a first content association and the user can be granted read and edit access by a second content associations. In one embodiment, a user is granted the highest level of access granted by the content associations.

In one embodiment, when a user leaves a network, community, or ecosystem, the user's access to content is disabled by using the permissions module 342 to change the membership and permissions information 313 associated with the user identifier 312 corresponding to the user, but content having a content description 317 associated with the user is not removed. Thus, if a user has provided read access to a piece of content to a particular network or community, the network or community would still be able to access the content after the user is disabled. This permits retention of content such even when a user is no longer associated with any network of the master ecosystem. This can offer a significant advantage over systems such as e-mail, where content associated with a particular user or account can be lost when the user or account becomes disabled. Upon disablement of a user, the content can remain associated with the user, or may be transferred to another user, including a network or community administrator. The transfer of the content can be achieved by updating the content description 317 associated with the content to indicate who the new owner is.

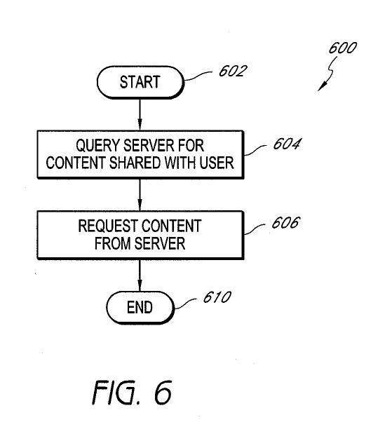

The content association 320 can be employed to create a relational association between content and particular users, communities and networks within the ecosystem. As will be described in detail below with reference to FIG. 6, an application on a user device can query the ecosystem server for content associated with a particular user, community or network, and the content associations within the networks databases can be employed to locate the appropriate content.

With continuing reference to FIG. 3A, the second ecosystem tables 306 include the content table 329 and the sharing table 330. Details of the content table 329 and the sharing table 330 can be similar to those of the content table 307 and sharing table 308 described above. For example, the sharing table 330 can be used as a means for sharing content between users, networks and/or communities of an ecosystem.

The illustrated master locator table 310 includes a network identifier 331, a network name 332, a database identifier 333, and a table identifier 334. The master locator table 310 can be employed to map a network name and/or identifier to a particular set of ecosystem related tables. The network identifier 331 can be used to uniquely identify the networks within a master ecosystem. Additionally, the network name 332 can identify the name of the network within the ecosystem. By using the network identifier 331 and/or network name 332, the master locator table 310 can be used to obtain a database identifier 333 and table identifier 334, which in turn can be used to locate content and content sharing data. Thus, the master locator table 310 permits a plurality of databases to be used to stored the ecosystem tables, thereby facilitating scaling of the server 301 to accommodate increased load.

As described above, the content storage 303 can be employed to store files of a relatively large size to aid in reducing the size of the content tables 307, 329. In one embodiment, the content storage 303 can include storage volumes having a web service interface, such as such as Amazon Simple Storage Service (S3).

The illustrated sever 301 also includes the update module 343, the cloning module 344, and the content retrieval module 345. The update module 343 can be used for updating one or more network tables to reflect the sharing of content within an ecosystem. In certain implementations, the cloning module 344 can be included and used to clone or duplicate particular communities, networks and/or ecosystems associated with the server upon request of a user with sufficient permission. The content retrieval module 345 can be used to provide a user with sufficient permissions to access content stored over a plurality of networks, including, for example, content in the content tables 307, 329 and/or the content storage 303. Additional details of the update module 343, the cloning module 344, and the content retrieval module 345 can be as described below with reference to FIGS. 4-6.

FIG. 3B is a schematic block diagram of a server 351 in accordance with another embodiment. The illustrated server 351 includes a database cluster 350, content storage 303, a permissions module 342, an update module 343, and a cloning module 344. The database cluster 350 includes a user table 302, first network tables 354, second network tables 356, a global content table 370, and a master locator table 310. As will be described in detail below, the database cluster 350 can be configured to share content over a plurality of networks and ecosystems within a master ecosystem, such as the master ecosystems 200, 250 of FIGS. 2A-2B. Although the server 351 is illustrated as a single server, the server 351 can comprise a multitude of servers to facilitate load balancing or other needs. The tables 302, 310, 354, 356, 370 can be distributed over one or more databases depending on a variety factors, including server load and frequency of access. Additional tables can be employed in addition to those shown below. For example, tables for additional networks can be added, as well as tables for storing addition information, such as auxiliary user data, can be added.

The user table 302 can include information about the users of the master ecosystem, and the ecosystems, networks and/or communities to which they belong. The user table 302 can include a user table entry 311 having user identification 312 and membership and permissions information 313. Additional details of the user table 302 can be as described above with reference to FIG. 3A.

The first network tables 354 can include a sharing table 357, as well as additional tables not shown. The sharing table 357 can include entries defining content sharing relationships over a master ecosystem. Thus, the sharing table 357 can be used as a means for sharing content between users, networks and/or communities of a master ecosystem. For example, the sharing table 357 can include a content association 360 having a source identifier 363, a source network identifier 364, a relationship 365, a target identifier 366, and a target network identifier 367. The source identifier 363 can be, for example, a pointer to a content identifier within a particular network, as will be described below. The content association 360 can also include the source network identifier 364 for identifying the network the content is associated with. As will be described in further detail below, the source network identifier 364 and the source identifier 363 can be employed to locate the content within a master ecosystem, such as the master ecosystems 200, 250 of FIGS. 2A-2B.

The content association 360 can further include the target identifier 366, which can identify the entity within a particular network which has been provided access to the content. In one embodiment, the target identifier 366 can be a user identifier, a community identifier, or a network identifier. The content association can further include the target network identifier 367, which can be used for identifying the network the target is associated with. The target network identifier 367 and the target identifier 366 can be used to identify a particular target entity within a master ecosystem.

With continuing reference to FIG. 3B, the content association 360 can also include relationship 365, which can indicate the type of sharing of the content association 360. For example, the relationship field 365 can indicate that the particular target identified by the target network identifier 367 and the target identifier 366 is a community permitted to edit or view the content. A particular piece of content can have a multitude of corresponding content associations 360 in the sharing table 357. Thus, content may be shared across particular users, communities, and networks within a master ecosystem, with varying degrees of access. Skilled artisans will appreciate that multiple content associations can result in a particular user receiving conflicting access levels. For example, a user can be a member of a particular community, and the community can be granted read access by a first content association and the user can be granted read and edit access by a second content associations. In one embodiment, a user is granted the highest level of access granted by the content associations.

The second network tables 356 can include a sharing table 358, as well as additional tables not shown. The sharing table 358 can include entries defining content sharing relationships over a master ecosystem. Additional details of the second network tables 356 and the sharing table 358 can be similar to those described above. For example, the sharing table 358 can be used as a means for sharing content between users, networks and/or communities of a master ecosystem.

The global content table 370 can include information about content distributed across the master ecosystem. The global content table 370 can include a content entry 371 corresponding to a piece of content in the master ecosystem. Each content entry 371 can include a network identifier 331, a content identifier 316, and a content description 317. Collectively, the network identifier 331 and the content identifier 316 can form a global unique identifier 372, which can be used to uniquely identify content within the master ecosystem. Thus, content may only be stored once within the master ecosystem, thereby improving data storage capacity and centralizing version control over the master ecosystem.

The illustrated database cluster 350 can also be used to share content in a master ecosystem that includes shared communities, such as the master ecosystem 250 of FIG. 2B. For example, when sharing content in the master ecosystem 250 of FIG. 2B using the shared community 258, the first sharing table 357 can be configured to store content associations associated with the first network 100 and the second sharing table 358 can be configured to store content associations associated with the third network 208. Additionally, the first and second sharing tables 357, 358 can each include a content association identifying the location of and sharing information related to content associated with the shared community 258. For example, the first sharing table 357 can include a content association identifying a location in the global content table 370 of the content and identifying the community 220 of the third network 208 as a target to share the content with. Similarly, the second sharing table 358 can include a content association identifying the location in the global content table 370 of the content and identifying the community 110 of the first network 100 as a target to share the content with.

In one embodiment, the content associations used to share content across a shared community each include a source identifier 363, a source network identifier 364, a relationship 365, a target identifier 366, and a target network identifier 367. The source identifier 363 and the source network identifier 364 can be used to locate the content in the global content table 370 by identifying a content identifier 316 and a network identifier 331 in the global content table 370, respectively. Additionally, the target network identifier 367 and the target identifier 366 can be used to identify a network and a community associated with the shared community, respectively. The relationship field 365 can be used to indicate the level of access of the particular target identified by the target network identifier 367 and the target identifier 366 has with respect to the content.

As shown in FIG. 3B, the illustrated master locator table 310 includes a network identifier 331, a network name 332, a database identifier 333, and a table identifier 334. Additional details of the master locator table 310 can be as described above, with reference to FIG. 3A.

In one embodiment, the database cluster 350 includes content storage 303. Additional details of the content storage 303 can be as described above with reference to FIG. 3A.

### Process Overview

FIG. 4 is a flowchart of a method 400 of updating one or more network tables to reflect the sharing of content within an ecosystem. It will be understood that not all of the illustrated steps are required, and that this method can be modified without departing from the spirit and scope of the invention.

The illustrated method 400 is depicted from the point of view of a server, such as the servers 301, 351 of FIGS. 3A-3B, and can be performed at least in part by the permissions module 342 and/or the update module 343. The method 400 starts at a state 402. In an ensuing decision block 404, the server determines if the user has permission to distribute the content. The permissions module 342 can make this determination, for example, by checking the user table entry 311 of the user table 302 associated with the user. Permission to distribute content can be set, for example, by a network or community administrator, and can be particular to certain users, communities, and/or content types. For example, a network administrator of a company support Website may wish to permit registered members of the public to view support content, but may not wish for these users to distribute content within the Website. Thus, the network can be configured so that particular users, or users who belong to particular communities, cannot distribute content. Likewise, members of a company intranet may be allowed to post blog content or respond on forums, but may not have permission to upload files, or particular files like those containing video or audio content. If the answer to the inquiry in the decision step 404 is no, then the method 400 proceeds to the step 406, in which an error handler returns an error message to the user.

If the answer to the inquiry in the decision block 404 is yes, the method 400 proceeds to the block 408, in which content is uploaded to the server. For example, a user desiring to distribute a spreadsheet file to a multitude of users can upload the document to the server from a device such as a personal computer, PDA or mobile phone. As was described above, the server can associate the content with a content identifier, and create a content entry in a content table corresponding to the newly uploaded content. If the content is a file or is relatively large, the content can be stored in content storage 303, and information needed to retrieve the content, as well as identification information of the content can be stored in the content description 317. In some embodiments, the content is stored in a content table associated with a particular network or ecosystem. However, skilled artisans will appreciate that content can also be stored in a global content table, as shown in FIG. 3B.

The method 400 continues to a block 410, in which the server receives a list of network, community, and/or users selected for distribution. For example, the server can receive a list of networks and/or communities for the content to be distributed from the user. The user can enter this information by using a user interface of a device such as a computer or mobile phone, by using one or more dropdown menus, input fields, or other mechanisms of the user interface. Thereafter, the list of networks, communities, and/or users targeted for distribution can be sent to the server, including information identifying which network name or network identifier the target entities are associated with.

In an ensuing block 412, the permissions module 342 requests and receives privacy and access control information from the user. For example, the user can select that a document can be viewed by members of multiple networks to which the user belongs, but may permit the document to be edited only by a particular community to which the user belongs. Likewise, a user may set a read privacy setting of a field to general public, permitting viewing of the content by persons external to the ecosystem, such as persons who are not logged in to any network of the ecosystem. In one embodiment, each recipient of the content can be granted access to view, edit, or own the content. Access to view the content can permit viewing of the content, but prohibit the content from being edited or deleted. The ability to edit the content can permit viewing and editing of the content, but may not permit deletion of the content. Ownership may permit deletion, editing or viewing of the content. Multiple users can be owners, and in certain circumstances the creator of the content can be permitted to select a different user, such as a different individual or a particular community, as the owner of the content. Persons of ordinary skill in the art will recognize that the server can receive the privacy and access control information at the same time as receiving the list of networks, communities, and/or users selected for distribution.

The method 400 proceeds to a decision block 414, in which the permissions module 342 determines if the list of distributed entities and access control information is valid. The permissions module 342 can validate that the user is a member of the particular network and communities, and can determine if the user is permitted to distribute content to the particular networks and communities using the information contained in the user table 302. The user table 302 may indicate that distribution of all or only certain types of content outside of the network or community is prohibited. For example, distribution may be prohibited for a company's finance intranet network. Likewise, particular communities within a network can be permitted to distribute to some entities, but not to others. If the answer to the inquiry in the decision block 414 is no, the method 400 proceeds to the step 406, which was described above.

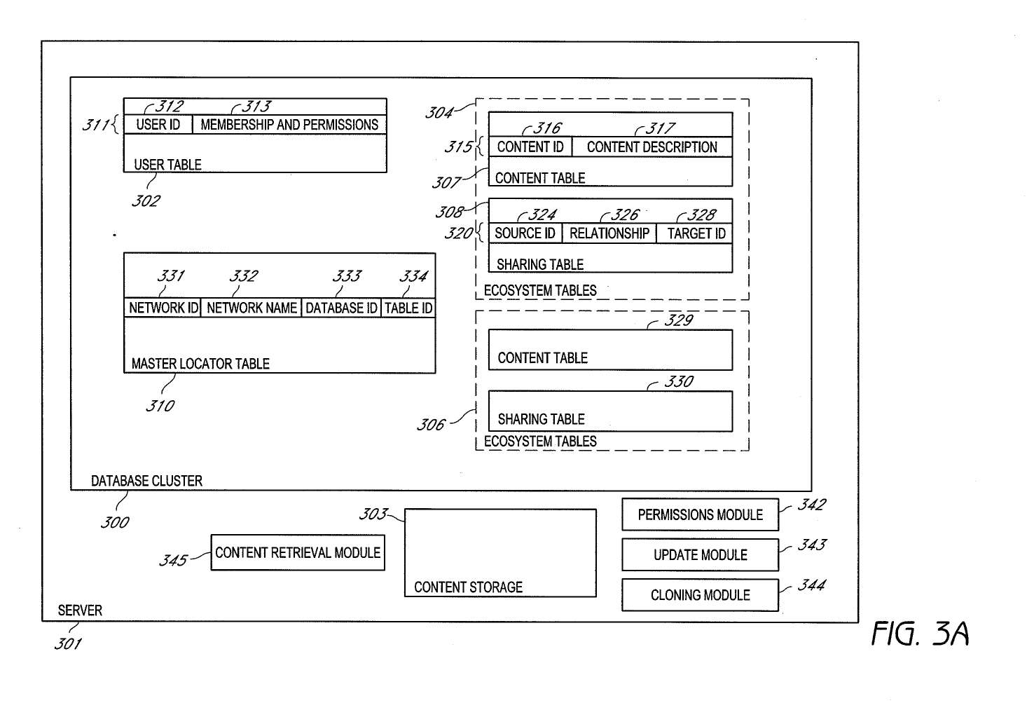

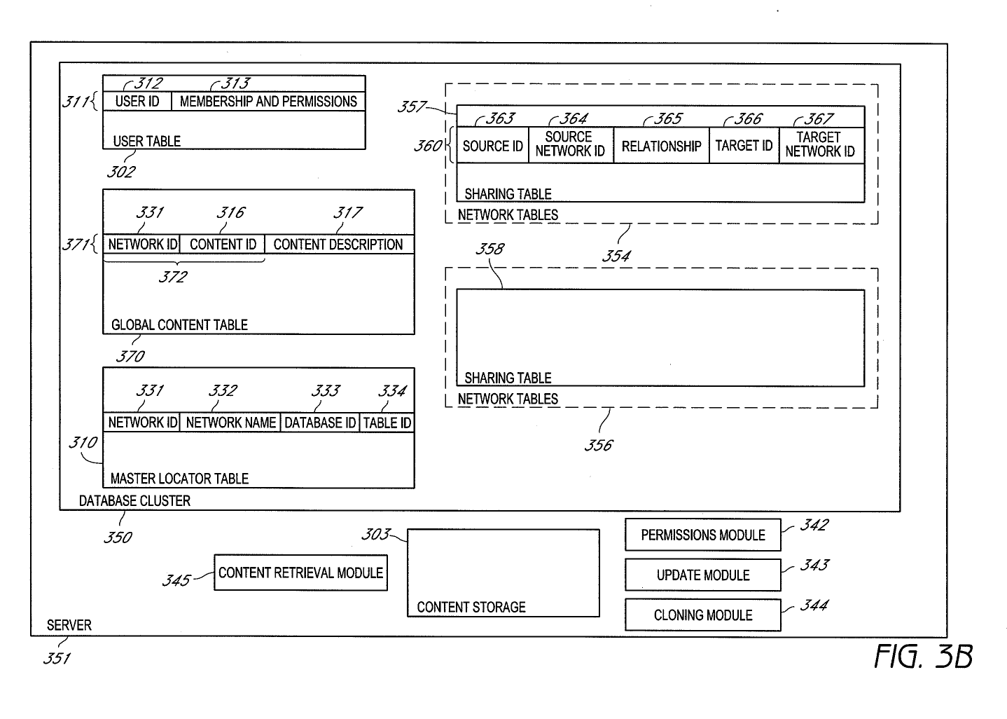

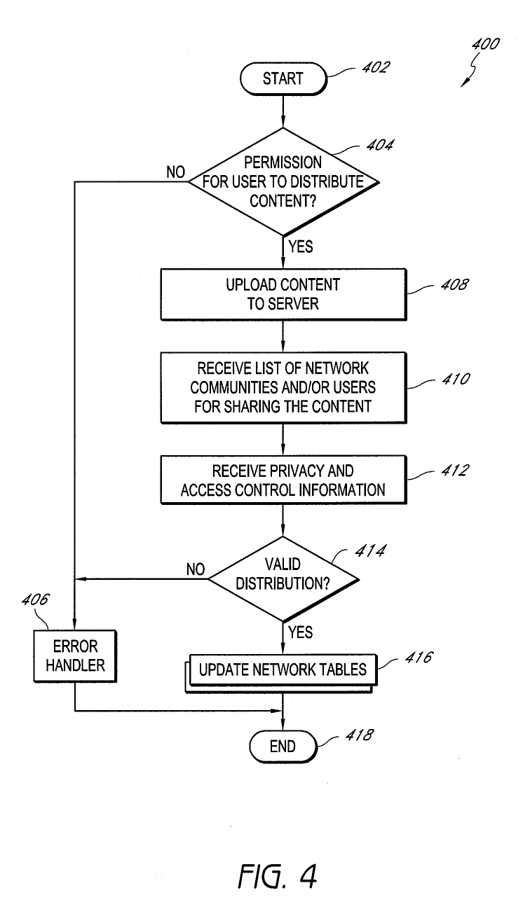

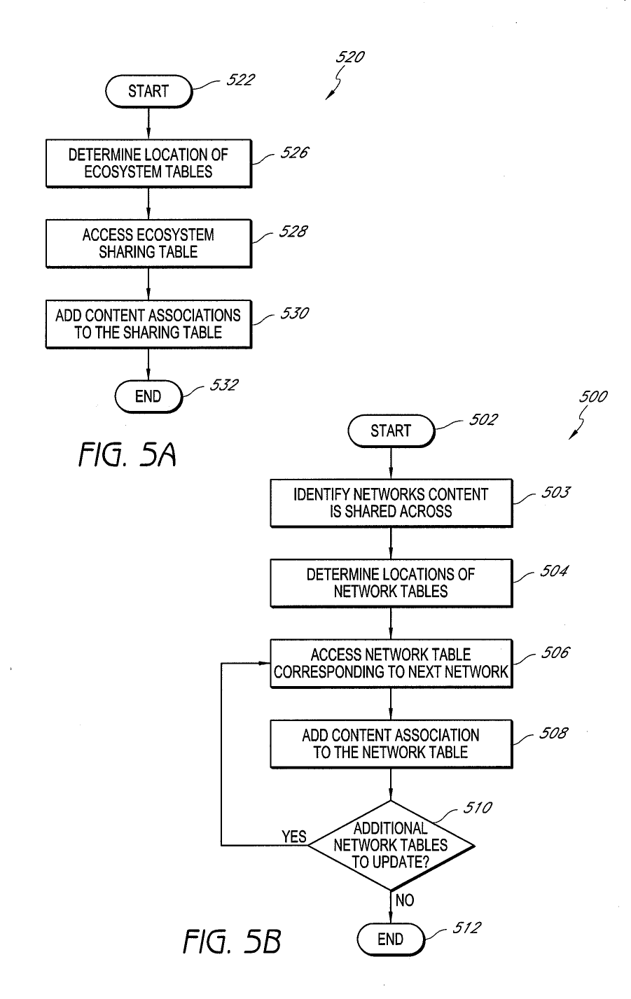

If the answer to the inquiry in the decision block 414 is yes, the method 400 proceeds to the block 416, in which one or more tables are updated to reflect the distribution. The details of the block 418 are described below with reference to FIGS. 5A-5B. The method 400 ends at 418.

FIG. 5A is a flowchart of a method by an update module 343 for updating one or more network tables to reflect the sharing of content within an ecosystem in accordance with one embodiment. It will be understood that not all of the illustrated steps are required, and that this method can be modified without departing from the spirit and scope of the invention.

The illustrated method 520, depicted from the point of view of a server, such as the sever 301 of FIG. 3A, starts at 522. In an ensuing block 526, the update module 343 identifies the location of the ecosystem tables the content is associated with. This can be performed by using the network identifier in which the content was stored, as determined above in step 404 of FIG. 4, to locate the tables using, for example, the master locator table 310. For instance, the network identifier can be used to locate the database identifier 333 and table identifier 334 in the master locator table 310.

The method 520 continues at a block 528, in which the update module 343 accesses the sharing table of the ecosystem by using the database identifier 333 and the table identifier 334. In an ensuing block 530, the update module 343 adds content association entries to the sharing table. With reference back to FIG. 3A, each added content association can include a source identifier 324, a relationship 326, and a target identifier 328. The update module 343 can add a content association entry for each recipient entity of the content within the ecosystem. Thus, if the content is to be distributed to a particular network of the ecosystem with read access, and to a particular user of the network with edit access, two association entries can be added to the network database. The first content association can identify the target as a particular network having read access, and the second content association can identify the target as a particular user having read and edit access. By including multiple content associations in the sharing table of the ecosystem, sharing of content within an ecosystem can be achieved. The method 520 ends at 532.

FIG. 5B is a flowchart of a method of updating one or more network tables to reflect the sharing of content within a master ecosystem in accordance with one embodiment. It will be understood that not all of the illustrated steps are required, and that this method can be modified without departing from the spirit and scope of the invention.

The illustrated method 500 in the update module 343, depicted from the point of view of a server, such as the sever 351 of FIG. 3B, starts at 502. In an ensuing block 503, the update module 343 identifies the networks in which content is shared across. This can be obtained by receiving a list of network identifiers associated with the networks, communities, and individual users which the content is to be shared, as was described above. Alternatively, the update module 343 can look to one or more tables, such as the user table 302, to determine the network identifier. For example, if a particular user is specified as a target for content to be shared with, the server can determine the network identifier associated with the user using the membership and permissions information 313 of the user table 302 for the particular user identifier 312.

In an ensuing block 504, the update module 343 determines the location of the network tables for the networks content is shared across. The location of the network tables can be determined using the master locator table 310. For example, the server can use the network identifier for each network the content will be shared to retrieve a database identifier 333 and table identifier 334 indicating where the appropriate network table can be located.

The method 500 continues at a block 506, in which the update module 343 accesses the network database corresponding to one of the networks which has not yet been updated. In an ensuing block 508, the update module 343 adds content association entries to sharing table. With reference back to FIG. 3B, each added content association can include a source identifier 363, a source network identifier 364, a relationship 365, a target identifier 366, and a target network identifier 367. The update module 343 can add a content association entry for each recipient entity of the content within this network. Thus, if the content is to be distributed to a particular community of the network with read access and to a particular user of the network with edit access, two association entries can be added to the network database. The first content association can identify the target as a particular community having read access, and the second content association can identify the target as a particular user having read and edit access. By including multiple content associations in a network database, distribution of content over a master ecosystem to one or more networks, communities, or users can be indicated, and each can have varying access permissions.

The method 500 continues to a decision block 510, in which the update module 343 determines if there are additional network tables to update. If the answer to the inquiry is yes, the method 500 proceeds to the step 506, discussed above. If the answer to the inquiry is no, the method 500 ends at 512.

FIG. 6 is a flowchart of a method 600 of retrieving content shared across a plurality of networks in accordance with one embodiment. It will be understood that not all of the illustrated steps are required, and that this method can be modified without departing from the spirit and scope of the invention.

The illustrated method 600, depicted from the point of view of the content retrieval module 345 module, starts at 602. The content retrieval module 345 can represent software configured to provide the user with content the user has access to over a plurality of networks.

The method 600 starts at 602. In an ensuing step 604, the content retrieval module 345 queries the server 301 for all content shared with the user. In response to the request, the server 301 can retrieve information about the user's networks and communities from the database cluster 300. The user table entry 311 retrieved from the user table 310 can indicate that the user is a member of one or more networks and/or communities. The server can then use the master locator table 310 to locate the database and tables where content may be found. The sharing table associated with the database identifier 333 and table identifier 334 can be searched for content associations 320 in which the target identifier 328 is that of a network or community to which the user belongs, or in which the user is identified specifically by the target identifier. Thus, server 301 can utilize the target identifier 328 to identify content related to a network, community or user.

The server can provide information related to the content to the user. For example, with reference back to FIG. 3A, the server 301 can use the source identifier 324 to locate the content description 317 and/or content identifier 316 and provide the information to the UI module.

In an ensuing step 606, the content retrieval module 345 can request one or more items of content from the server by providing, for example, the content identifier 316 and the network identifier 331 where the content is located to the server. The content retrieval module 345 can use the network identifier 331 and the content identifier 316 to locate the content. For example, in the embodiment illustrated in FIG. 3A, the content retrieval module 345 can use the master locator table 310 to identify the database and table where the content is located. Once the appropriate content table is accessed, the content can be located using the content identifier 316. However, in other embodiments, a global content table may be accessed by the content retrieval module 345 to obtain the content. For example, in the embodiment illustrated in FIG. 3B, content can be accessed from the global content table 370 using the network identifier 331 and the content identifier 316. After retrieving the content either directly from the content table or using a pointer to a location in the content storage 303, the content can be provided to the content retrieval module 345. The method 600 ends at 612.

### Cloning Overview

In one embodiment, particular communities, networks or ecosystems can be cloned or duplicated by a cloning module 344 associated with a server upon request of a user with sufficient permission. The cloned community, network or ecosystem can keep the same look and feel, content, and users. Thus, if an ecosystem had a separate network for each supplier of the business or other organization, a network associated with a new supplier could be created by cloning a network of an existing supplier. The copy of the network would initially have the same communities, content and users, thereby minimizing the work associated with setting up a network for a new supplier. Additionally, the new network could be initially associated with certain communities, such as an accounting or sales group. The cloned network could thereafter be modified to include new communities, users, or content specific to the new retailer.

All of the features described above may be embodied in, and automated by, software modules executed processors or integrated circuits of general purpose computers. The software modules may be stored in any type of computer storage device or medium. All combinations of the various embodiments and features described herein fall within the scope of the present invention.

Although the various inventive features and services have been described in terms of certain preferred embodiments, other embodiments that are apparent to those of ordinary skill in the art, including embodiments which do not provide all of the benefits and features set forth herein and do not address all of the problems set forth herein, are also within the scope of this invention. The scope of the present invention is defined only by reference to the appended claims.

What is claimed is:

1. A method in a server for sharing content over a collection of social networks, the method comprising:
receiving a first content from a first user of a first social network;
receiving information identifying a second social network; and
sharing the first content with the second network by providing a content association to a sharing table.

2. The method of claim 1, further comprising determining if the first user has permission to distribute the content to the second network.

3. The method of claim 1, further comprising determining if the first user has permission to upload the first content.

4. The method of claim 1, wherein providing the content association comprises providing a source identifier and a target identifier.

5. The method of claim 4, wherein the target identifier identifies the second social network, a community of the second social network, or a user of the second social network.

6. The method of claim 1, wherein adding the content association further comprises providing a relationship of the source identifier and the target identifier.

7. The method of claim 6, wherein the relationship comprises an access permission.

8. The method of claim 1, wherein the first social network comprises a company intranet.

9. The method of claim 1, wherein the first social network comprises a first community having a plurality of users as members, and wherein the first user is a member of the first community, and wherein the method further comprises sharing the first content with the first social network by providing a content association to the sharing table.

10. The method of claim 1, wherein the first and second social networks are in the same ecosystem.

11. The method of claim 1, wherein the first and second social networks are in a different ecosystem.

12. The method of claim 1, wherein the first content comprises at least one of a document, a digital image, a digital video, a blog entry, and a forum post.

13. The method of claim 1, further comprising using, the content identifier to locate the first content within a global content table.

14. The method of claim 1, further comprising sharing content within a shared community by providing one or more content identifiers to one or more sharing tables associated with the shared community.

15. A system for sharing content over a collection of social networks, the system comprising:
a first social network;
a second social network; and
at least one sharing table for sharing a first content from the first social network with the second social network.

16. The system of claim 15, wherein the first social network comprises a plurality of users, and wherein the at least one sharing table is further configured to share the first content to a first user of the users.

17. The system of claim 16, wherein the first social network comprises a first community having at least a portion of the users as members, wherein the at least one sharing table is further configured to distribute the first content to the first community.

18. The system of claim 15, wherein the first social network comprises a company intranet.

19. The system of claim 15, wherein the first content comprises at least one of a document, a digital image, a digital video, a blog entry, and a forum post.

20. The system of claim 15, wherein the at least one sharing table is further configured to contain access control information for the first content.

21. The system of claim 15, wherein the access control information comprises read and edit permissions.

22. The system of claim 15, the at least one sharing table includes at least one content association having a source identifier and a content identifier.

23. The system of claim 15, wherein the at least one sharing table includes information indicating the relationship of the sharing between the source identifier and the content identifier.

24. The system of claim 15, further comprising a global content table for storing content associated with the first and second social networks including the first content, and wherein the at least one sharing table includes a first sharing table associated with the first social network and a second sharing table associated with the second social network.

25. The system of claim 24, further comprising a shared community including a first community of the first social network and a second community of the second social network, and wherein the first and second sharing tables each include a content identifier identifying a second content of the global content table.

26. A non-transitory computer-readable storage medium comprising instructions that when executed perform a method in a server for sharing content over a collection of social networks, the method comprising:
receiving a first content from a first user of a first social network;
receiving information identifying a second social network; and
sharing the first content with the second network by providing a content association to a sharing table.

27. A system for sharing content over a collection of social networks, the system comprising:
a first social network;
a second social network; and
at least one means for sharing a first content from the first social network with the second social network.
